(19) United States
(12) Patent Application Publication
(10) Pub. No.: US 2026/0189530 A1
(43) Pub. Date: Jul. 2, 2026

(54) AUTOMATED LIGHTWEIGHT ACTIVE DIRECTORY PROTOCOL (LDAP) CONSOLIDATION VIA LDAP DISCOVERY

(71) Applicant: Charter Communications Operating, LLC, St. Louis, MO (US)

(72) Inventor: Saran Khalid, Denver, CO (US)

(21) Appl. No.: 19/004,583

(22) Filed: Dec. 30, 2024

(51) Int. Cl. H04L 61/4523; H04L 67/1004

(52) U.S. Cl. CPC H04L 61/4523; H04L 67/1004

(57) ABSTRACT

Methods and systems for automatically discovering and consolidating lightweight active directory protocol (LDAP) servers into a centralized-LDAP (C-LDAP) are described. A method includes initiating, by an orchestration engine, automated discovery of LDAP systems deployed across an entity, establishing, by the orchestration engine, secure connections between a centralized LDAP (C-LDAP) system and identified LDAP systems, forming, by the orchestration engine, a partitioned directory database in response to data from the identified LDAP systems, requesting, by the orchestration engine, each directory database associated with the identified LDAP systems to transfer directory data to the partitioned directory database, instructing, by the orchestration engine, one or more domain name system (DNS) servers to resolve requests directed to the identified LDAP systems to the C-LDAP system, and repurposing one or more of the identified LDAP systems.

### TECHNICAL FIELD

This disclosure relates to network management and access. More specifically, automated discovery and formation of a centralized lightweight active directory protocol (C-LDAP) based on LDAPs deployed in a network.

### BACKGROUND

Lightweight active directory protocol (LDAP) is a protocol for accessing compute and network recourses within an organization. LDAP is a standard protocol designed to maintain and access directory services with a network. It is used to authenticate users to internal resources such as applications and servers. It allows users to find various resources as if they are centrally available, e.g., printers, applications and severs. LDAP is usually implemented on a server and referred to as LDAP server(s). Enterprises can use multiple LDAP servers to provide authentication of users and devices on the enterprise network(s). These LDAP servers can be located in multiple locations based on office locations, number of employees, organizational structure, and/or combinations thereof. This usually means that users must be entered into each individual LDAP server to allow the user to enter the given system. In addition, for different networks, users may have different LDAP servers and must enter different credentials. Having multiple LDAP servers with multiple sets of credentials makes it difficult, cause potential security issues, inefficient, and/or combinations thereof.

### SUMMARY

Disclosed is a system and method for automatically discovering and consolidating lightweight active directory protocol (LDAP) servers into a centralized-LDAP (C-LDAP). In implementations, a method includes initiating, by an orchestration engine, automated discovery of LDAP systems deployed across an entity, establishing, by the orchestration engine, secure connections between a centralized LDAP (C-LDAP) system and identified LDAP systems, forming, by the orchestration engine, a partitioned directory database in response to data from the identified LDAP systems, requesting, by the orchestration engine, each directory database associated with the identified LDAP systems to transfer directory data to the partitioned directory database, instructing, by the orchestration engine, one or more domain name system (DNS) servers to resolve requests directed to the identified LDAP systems to the C-LDAP system, and repurposing one or more of the identified LDAP systems.

### BRIEF DESCRIPTION OF THE DRAWINGS

The disclosure is best understood from the following detailed description when read in conjunction with the accompanying drawings. It is emphasized that, according to common practice, the various features of the drawings are not to scale. On the contrary, the dimensions of the various features are arbitrarily expanded or reduced for clarity.

FIG. 1 is a diagram of an example of a lightweight active directory protocol (LDAP).

FIG. 2 is a diagram of an example of an enterprise with multiple LDAP servers.

FIG. 3 is a diagram of an example of an enterprise with a centralized LDAP system in accordance with the teachings described herein.

FIG. 4 is a flow diagram of an example of a system for automated consolidation of LDAPs to a centralized or consolidated LDAP in accordance with the teachings described herein.

FIG. 5 is a flow diagram of an example of a centralized or consolidated LDAP system with defined local LDAP in accordance with the teachings described herein.

FIG. 6 is a flowchart of an example method for automated consolidation of LDAPs to a centralized or consolidated LDAP in accordance with the teachings described herein.

FIG. 7 is a block diagram of an example of a device in accordance with the teachings described herein.

### DETAILED DESCRIPTION

Reference will now be made in greater detail to embodiments, examples of which are illustrated in the accompanying drawings. Wherever possible, the same reference numerals will be used throughout the drawings and the description to refer to the same or like parts.

As used herein, the terminology “server”, “computer”, “computing device or platform”, or “cloud computing system” includes any unit, or combination of units, capable of performing any method, or any portion or portions thereof, disclosed herein. For example, the “server”, “computer”, “computing device or platform”, or “cloud computing system” may include at least one or more processor(s).

As used herein, the terminology “processor” or “processing circuitry” indicates one or more processors, such as one or more special purpose processors, one or more digital signal processors, one or more microprocessors, one or more controllers, one or more microcontrollers, one or more application processors, one or more central processing units (CPU)s, one or more graphics processing units (GPU)s, one or more digital signal processors (DSP)s, one or more application specific integrated circuits (ASIC)s, one or more application specific standard products, one or more field programmable gate arrays, any other type or combination of integrated circuits, one or more state machines, or any combination thereof.

As used herein, the term “engine” may include software, hardware, or a combination of software and hardware. An engine may be implemented using software stored in the memory subsystem. Alternatively, an engine may be hard-wired into processing circuitry. In some cases, an engine includes a combination of software stored in the memory and hardware that is hard-wired into the processing circuitry.

As used herein, the terminology “memory” indicates any computer-usable or computer-readable medium or device that can tangibly contain, store, communicate, or transport any signal or information that may be used by or in connection with any processor. For example, a memory may be one or more read-only memories (ROM), one or more random access memories (RAM), one or more registers, low power double data rate (LPDDR) memories, one or more cache memories, one or more semiconductor memory devices, one or more magnetic media, one or more optical media, one or more magneto-optical media, or any combination thereof.

As used herein, the term “memory” includes one or more memories, where each memory may be a computer-readable medium. A memory may encompass memory hardware units (e.g., a hard drive or a disk) that store data or instructions in software form. Alternatively or in addition, the memory may include data or instructions that are hard-wired into processing circuitry. The memory may include a single memory unit or multiple joint or disjoint memory units, which each of the multiple joint or disjoint memory units storing all or a portion of the data described as being stored in the memory.

As used herein, the terminology “instructions” may include directions or expressions for performing any method, or any portion or portions thereof, disclosed herein, and may be realized in hardware, software, or any combination thereof. For example, instructions may be implemented as information, such as a computer program, stored in memory that may be executed by a processor to perform any of the respective methods, algorithms, aspects, or combinations thereof, as described herein. For example, the memory can be non-transitory. Instructions, or a portion thereof, may be implemented as a special purpose processor, or circuitry, that may include specialized hardware for carrying out any of the methods, algorithms, aspects, or combinations thereof, as described herein. In some implementations, portions of the instructions may be distributed across multiple processors on a single device, on multiple devices, which may communicate directly or across a network such as a local area network, a wide area network, the Internet, or a combination thereof.

As used herein, the term “application” refers generally to a unit of executable software that implements or performs one or more functions, tasks, or activities. For example, applications may perform one or more functions including, but not limited to, telephony, web browsers, e-commerce transactions, media players, scheduling, management, smart home management, entertainment, and the like. The unit of executable software generally runs in a predetermined environment and/or a processor.

As used herein, the terminology “determine” and “identify,” or any variations thereof includes selecting, ascertaining, computing, looking up, receiving, determining, establishing, obtaining, or otherwise identifying or determining in any manner whatsoever using one or more of the devices and methods are shown and described herein.

As used herein, the terminology “example,” “the embodiment,” “implementation,” “aspect,” “feature,” or “element” indicates serving as an example, instance, or illustration. Unless expressly indicated, any example, embodiment, implementation, aspect, feature, or element is independent of each other example, embodiment, implementation, aspect, feature, or element and may be used in combination with any other example, embodiment, implementation, aspect, feature, or element.

As used herein, the terminology “or” is intended to mean an inclusive “or” rather than an exclusive “or.” That is, unless specified otherwise, or clear from context, “X includes A or B” is intended to indicate any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from the context to be directed to a singular form.

As used herein, unless explicitly stated otherwise, any term specified in the singular may include its plural version. For example, “a computer that stores data and runs software,” may include a single computer that stores data and runs software or two computers - a first computer that stores data and a second computer that runs software. Also “a computer that stores data and runs software,” may include multiple computers that together stored data and run software. At least one of the multiple computers stores data, and at least one of the multiple computers runs software.

Further, for simplicity of explanation, although the figures and descriptions herein may include sequences or series of steps or stages, elements of the methods disclosed herein may occur in various orders or concurrently. Additionally, elements of the methods disclosed herein may occur with other elements not explicitly presented and described herein. Furthermore, not all elements of the methods described herein may be required to implement a method in accordance with this disclosure and claims. Although aspects, features, and elements are described herein in particular combinations, each aspect, feature, or element may be used independently or in various combinations with or without other aspects, features, and elements.

Further, the figures and descriptions provided herein may be simplified to illustrate aspects of the described teachings and/or embodiments that are relevant for a clear understanding of the herein disclosed processes, machines, and/or manufactures, while eliminating for the purpose of clarity other aspects that may be found in typical similar devices, systems, and methods. Those of ordinary skill may thus recognize that other elements and/or steps may be desirable or necessary to implement the devices, systems, and methods described herein. However, because such elements and steps do not facilitate a better understanding of the disclosed teachings and/or embodiments, a discussion of such elements and steps may not be provided herein. However, the present disclosure is deemed to inherently include all such elements, variations, and modifications to the described aspects that would be known to those of ordinary skill in the pertinent art in light of the discussion herein.

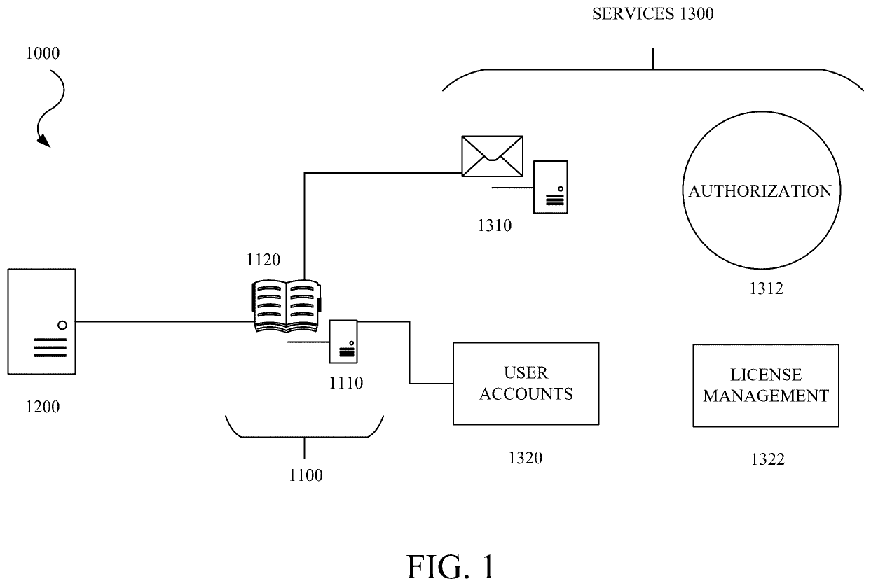

FIG. 1 is a diagram of an example of a network, and/or architecture 1000 using a lightweight active directory protocol (LDAP) system 1100. The network 1000 can include, but is not limited to, the LDAP system 1100, devices and/or applications 1200, and services and/or resources 1300 that can be used by the devices and/or applications 1200. The LDAP system 1100 can include, but is not limited to, a LDAP server 1110 and a directory database 1120. The directory database 1120 can include multiple entries, where each entry can include, but is not limited to, user, group, permission information, and/or credentials information such as a username and password (collectively “user identity data”) and other information typically stored in a directory database for a LDAP system as is known to one of skill in the art. The services 1300 can include, but is not limited to, email server(s) 1310 with associated authorization information 1312, and user account(s) 1320 and associated license management information 1322. The LDAP system 1100 can control access to the services 1300.

Operationally, in order to access the services 1300 within the network 1000, an end user uses an LDAP client (an LDAP-ready system or application), such as the application 1200, to establish a secure connection with the LDAP system 1100. For example, the LDAP system 1100 can use secure sockets layer (SSL) and/or transport layer security (TLS) to securely share the information to ensure integrity. The LDAP client can send a request to access information stored within the LDAP system 1100 and/or the directory database 1120. For example, the end user can send a “search” query to the directory database 1120 for a specific device. The request can include the LDAP system 1100 user credentials (username and password). The LDAP system 1100 can authenticate the end user by cross-checking the submitted credentials against the user identity data stored in its directory database 1120. The search operation is performed within the directory database 1120, and the address of the requested device is returned if successfully authenticated. Incorrect credentials will lead to denied access to the LDAP system 1100. The secure connection to the LDAP system 1100 is then closed.

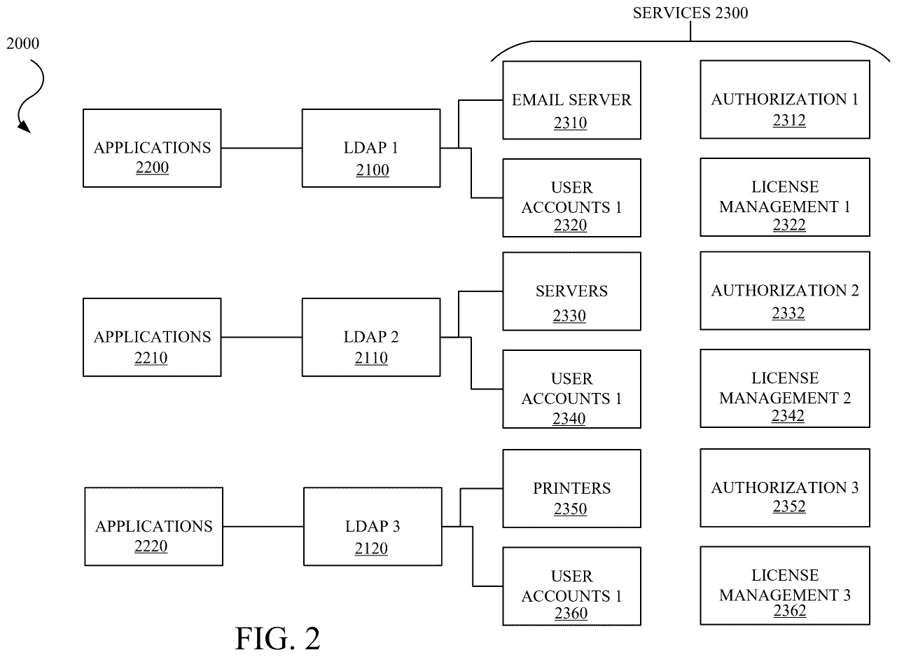

FIG. 2 is a diagram of an example of an enterprise network 2000 with multiple LDAP systems 2100, 2110, and 2120. The enterprise network 2000 can include, but is not limited to, the LDAP systems 2100, 2110, and 2120, devices and/or applications 2200, 2210, and 2220, and services and/or resources 2300 that can be used by the devices and/or applications 2200, 2210, and 2220, respectively. The LDAP systems 2100, 2110, and 2120 can include, but is not limited to, a LDAP server 2102 and a directory database 2104, a LDAP server 2112 and a directory database 2124, and a LDAP server 2122 and a directory database 2124, respectively. Each of the LDAP systems 2100, 2110, and 2120 is a local LDAP system in the enterprise network 2000. The services and/or resources 2300 can include, but is not limited to, email server(s) 2310 with associated authorization information 2312, user account(s) 2320 and associated license management information 2322, server(s) 2330 with associated authorization information 2332, user account(s) 2340 and associated license management information 2342, and printer(s) 2350 with associated authorization information 2352, user account(s) 2360 and associated license management information 2362. Each of the LDAP systems 2100, 2110, and 2120 can control local access to the email server(s) 2310 with associated authorization information 2312 and the user account(s) 2320 and associated license management information 2322, the server(s) 2330 with associated authorization information 2332 and the user account(s) 2340 and associated license management information 2342, and the printer(s) 2350 with associated authorization information 2352 and the user account(s) 2360 and associated license management information 2362, respectively. The LDAP systems 2100, 2110, and 2120 can function as described for the LDAP system 1100 of FIG. 1.

These LDAP servers 2100, 2110, and 2120 can be located in multiple locations based on office locations, number of employees, organizational structure, and/or combinations thereof. This usually means that users must be entered into each of the individual LDAP servers 2100, 2110, and 2120 to allow the user to access to the respective services. As shown, users have to access different LDAP servers for different services and therefore, must enter different credentials. Having multiple LDAP servers with multiple sets of credentials is difficult, causes potential security issues, is inefficient, and/or combinations thereof. For example, users must be manually added to each different LDAP system for access to the resources that a particular local LDAP system controls.

Described herein is a system and method for automated discovery and consolidation of multiple LDAP systems into a consolidated and/or centralized-LDAP (C-LDAP) system. In implementations, an automated mechanism and/or system consolidates local LDAP systems into a central system with defined policies instead of individual local LDAP systems. The system can appoint one of the local LDAPs as the C-LDAP or deploy a new server as a C-LDAP system. The system can obtain and/or collect, via a discovery process and/or mechanism, local LDAPs in a network. In implementations, one of the local LDAP systems can then be appointed as the C-LDAP system. The C-LDAP system can gather and/or obtain data from the local LDAP systems across an enterprise even if the LDAP systems are in different networks. In implementations, once the data is received at and confirmed by the C-LDAP system, the local LDAP systems can be repurposed, shut down, and/or combinations thereof. In implementations, one or more of the local LDAP systems can perform as a load balancer system, as an advanced, high-level, and/or second level security system, a back-up C-LDAP system, and/or combinations thereof. In the C-LDAP system, one pair of credentials can be used to provide authorization throughout the organization i.e., instead of having to use multiple pairs of credentials. User data entry into the C-LDAP system is centralized, making it easier for users to have credentials updated for services present in the organization irrespective of network.

The described system can provide unified access management, reduce account management, and bring convenience to the end users and applications in use. This disclosure automates the overall process and therefore needs minimal to no end user interruption and/or involvement. Organization can centrally enforce policies i.e., certain types of credentials, length of credentials, and which credentials should be used.

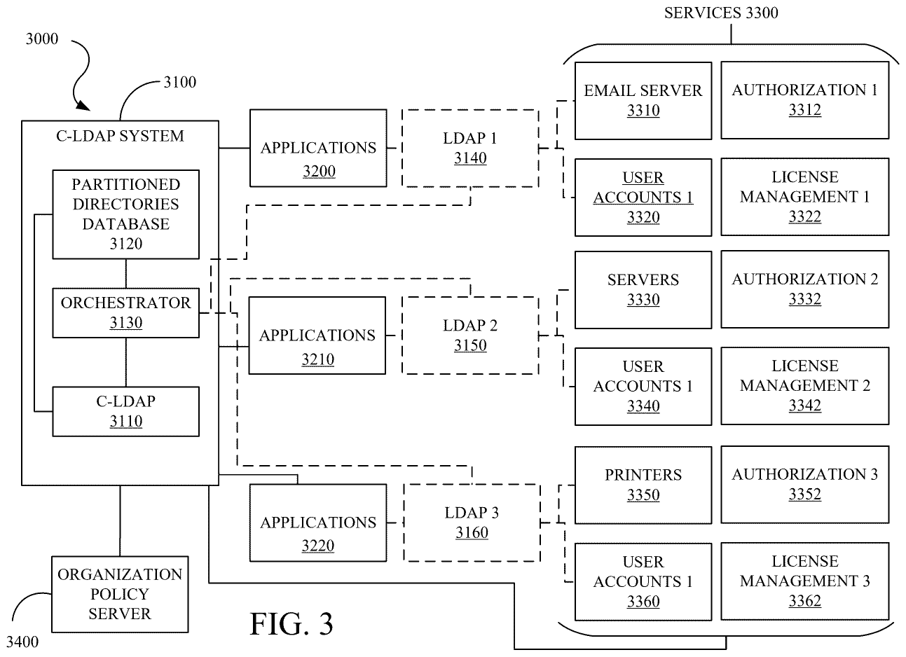

FIG. 3 is a diagram of an example of a network, system, and an enterprise 3000 with a C-LDAP system 3100 in accordance with the teachings described herein. The enterprise 3000 can include, but is not limited to, the C-LDAP system 3100, applications 3200, 3210, and 3220, services 3300, and organization and/or enterprise rules and/or policy server 3400. Prior to discovery and consolidation, the enterprise 3000 can include local LDAP systems 3140, 3150, and 3160. The number of components shown herein are illustrative and there may be more or less in the enterprise 3000. The enterprise 3000 and the components therein may include other elements which may be desirable or necessary to implement the devices, systems, and methods described herein. However, because such elements and steps do not facilitate a better understanding of the disclosed teachings and/or embodiments, a discussion of such elements and steps may not be provided herein.

Prior to discovery and consolidation as described herein, the local LDAP systems 3140, 3150, and 3160 can operate and function as local LDAP systems as described herein with respect to FIG. 1 and FIG. 2. Post consolidation, the local LDAP systems 3140, 3150, and 3160 can be repurposed as a load balancer system, repurposed as an enhanced security system, turned off and/or deactivated, and/or combinations thereof.

In implementations, the C-LDAP system 3100 can include a C-LDAP server 3110, a partitioned directory database 3120, and an orchestration and/or consolidation engine and/or controller and/or orchestrator 3130. The C-LDAP server 3110 can function and operate as described for a local LDAP and can include functionality to work with the partitioned directory database 3120 to respond to requests from the applications 3200, 3210, and 3220. The C-LDAP server 3110 can work with the orchestration engine and/or orchestrator 3130 to configure the C-LDAP server 3110 to work with the partitioned directory database 3120. In implementations, the C-LDAP server 3110 can work with one or more repurposed LDAP systems to provide load balance, enhanced security, and/or other services.

The partitioned directory database 3120 can hold user identified data and other information typically stored in a directory database for a LDAP system as is known to one of skill in the art. The partitioned directory database 3120 can be partitioned and populated as described herein via the orchestration engine and/or orchestrator 3130.

The orchestration engine and/or orchestrator 3130 can send commands to identify and/or initiate discovery of local LDAP systems, such as the local LDAP systems 3140, 3150, and 3160. The orchestration engine and/or orchestrator 3130 can partition a directory database to form the partitioned directory database 3120 based on a number of LDAP systems discovered. The orchestration engine and/or orchestrator 3130 can command the discovered LDAP systems to copy and send data from a local directory database to the partitioned directory database 3120. The orchestration engine and/or orchestrator 3130 can command Domain Name System (DNS) server(s) to resolve and/or redirect all requests and/or inquiries to the C-LDAP system 3100.

In implementations, the organization and/or enterprise rules and/or policy server 3400 can provide policies, rules, user(s) access permissions, and/or related information to the C-LDAP system 3100. The organization and/or enterprise rules and/or policy server 3400 provides the user(s) a single administrative entry point to add their credentials to the C-LDAP system to obtain access to the services.

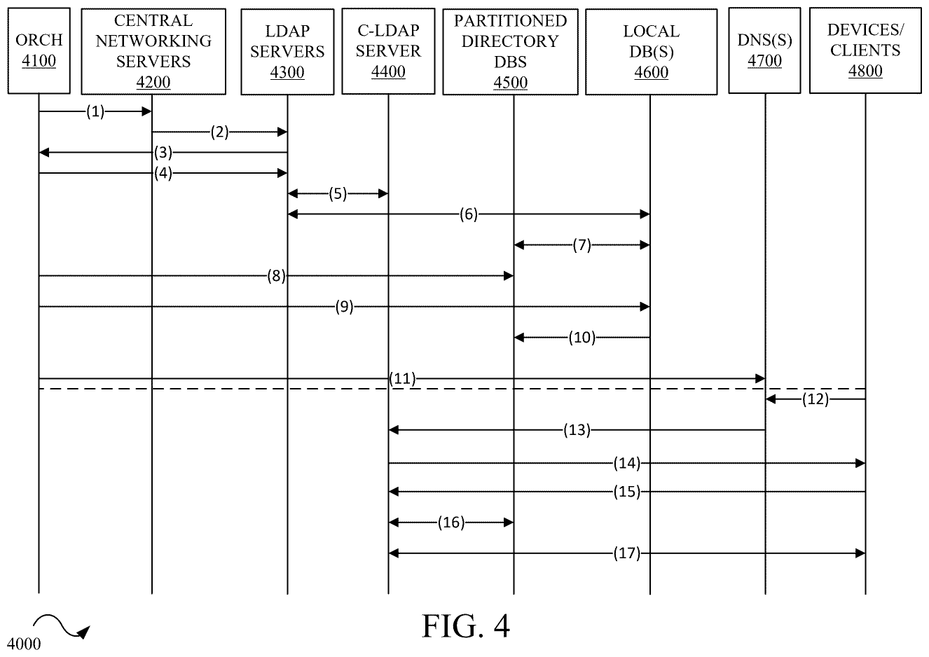

FIG. 4 is a flow 4000 of an example of a system for automated consolidation of LDAPs to a centralized or consolidated LDAP in accordance with the teachings described herein. The flow 4000 is performed between an orchestration engine 4100, one or more central networking servers 4200, one or more local LDAP servers 4300, a C-LDAP server 4400, partitioned directory database 4500, one or more local databases 4600, one or more domain name system (DNS) servers 4700, and one or more devices/clients 4800. Each of the components listed in FIG. 4 can function as described herein with respect to FIGS. 2-3 and 6-8. Actions 1-11 are directed to consolidation and actions 12-17 are an example request.

The orchestration engine 4100 can send a command to look-up, identify, and/or initiate discovery of LDAP servers, such as the local LDAP servers 4300, which are present in one or more networks deployed in and/or across an enterprise and/or organization (1). In implementations, the command can be sent to the one or more central networking servers 4200, which can have data relevant to the LDAP servers being used in the enterprise and/or reach out to the local LDAP servers 4300 (2). The orchestration engine 4100 can receive data from the LDAP servers 4300 (3). The orchestration engine 4100 can send a command to the LDAP servers 4300 to initiate a secure connection on behalf of the C-LDAP server 4400 and the partitioned directory database 4500 (4). The local LDAP servers 4300 and local databases 4600 can establish secure connections with the C-LDAP server 4400 and the partitioned directory database 4500 (5, 6, and 7). In implementations, the secure connections can be SSL and/or TLS tunnels. The orchestration engine 4100 can partition the partitioned directory database 4500 in accordance with the number of local LDAP servers 4300 and associated local databases 4600, and assign names and/or identifiers with respect to which partition corresponds to which of the local LDAP servers 4300 (8). The orchestration engine 4100 can command and/or request the local databases 4600 to copy the directory database data for transfer to the partitioned directory database 4500 (9). The local databases 4600 can transfer the directory database data to the partitioned directory database 4500 (10). The orchestration engine 4100 can command and/or request the DNS servers 4700 to redirect or resolve toward the C-LDAP server 4400 and discontinue resolving toward the local LDAP servers 4300 (11). The local LDAP servers 4300 and associated local databases 4600 can then repurposed, reassigned, removed, and/or combinations thereof.

In an example request, the devices/clients 4800 can send a request/address resolution to the DNS servers 4700 (12), which in turn resolves and/or forwards the request to the C-LDAP server 4400 (13). The C-LDAP server 4400 can request authentication credentials from the devices/clients 4800(14 ), which in turn can provide the requested authentication credentials to the C-LDAP server 4400 (15). The C-LDAP server 4400 and the partitioned directory database 4500 can process the request, authentication credentials, and relevant data in the partitioned directory database 4500 to determine network, user role, user permissions, and/or perform other standard LDAP processing as is known to one of ordinary skill in the art (16). The C-LDAP server 4400 and the devices/clients 4800 perform handshaking and message exchanges to determine grant or denial access to the services made in the request (17).

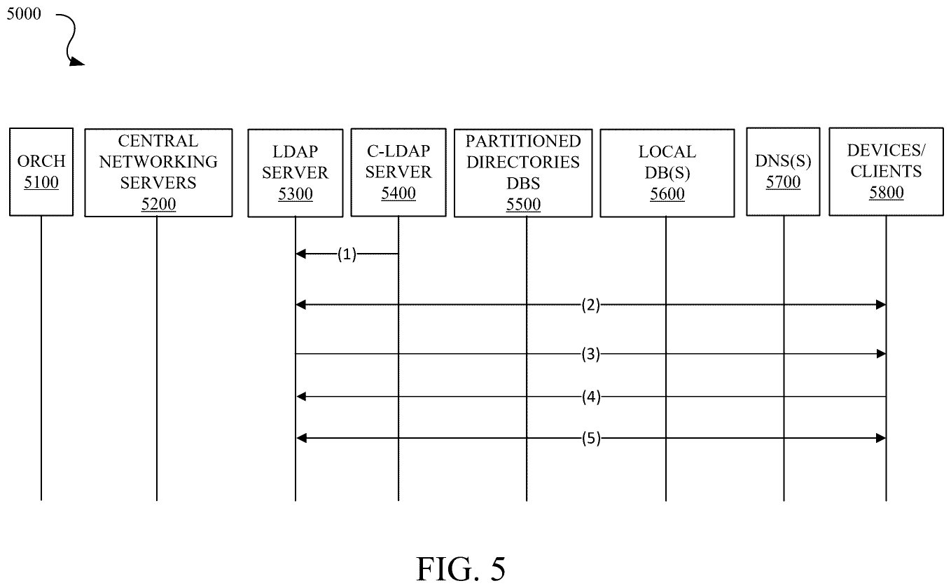

FIG. 5 is a flow 5000 of an example of a centralized or consolidated LDAP system with a local LDAP as a security server in accordance with the teachings described herein. The flow 5000 is performed between a security LDAP server 5300, a C-LDAP server 5400, and and one or more devices/clients 5800. Each of the components listed in FIG. 5 can function as described herein with respect to FIGS. 3-4 and 6-8. An orchestration engine 5100, one or more central networking servers 5200, a partitioned directory database 4500, one or more local databases 4600, and one or more domain name system (DNS) servers 4700 are shown for context in relation to FIG. 4. In implementations, the security LDAP server 5300 is a repurposed LDAP server that has been consolidated, such as one of the local LDAP servers 4300.

The flow 5000 assumes that the actions in FIG. 4 have been completed except as noted herein below. During the process of authenticating the one or more devices/clients 5800 (e.g., one or more devices/clients 4800 in FIG. 4), the C-LDAP server 5400 can determine that the devices/clients 5800 and/or request requires an additional level of security for accessing the services. In this instance, the C-LDAP server 5400 can transfer the request to the security LDAP server 5300 (1). The security LDAP server 5300 can initiate and establish a secure connection with the devices/clients 5800 (2 ). The security LDAP server 5300 can request additional authentication credentials from the devices/clients 5800 (3), which in turn can provide the requested authentication credentials to the security LDAP server 5300 (4). The security LDAP server 5300 and the devices/clients 4800 perform handshaking and message exchanges to determine grant or denial access to the services made in the request (5).

In implementations, one of the local LDAP servers 4300 can be repurposed as a load balancing LDAP server. In implementations, the C-LDAP server 5400 can initiate load balancing with the load balancing LDAP server when one or more requests trigger a defined processing threshold. In this instance, the C-LDAP server 5400 can forward the one or more requests to the load balancing LDAP server.

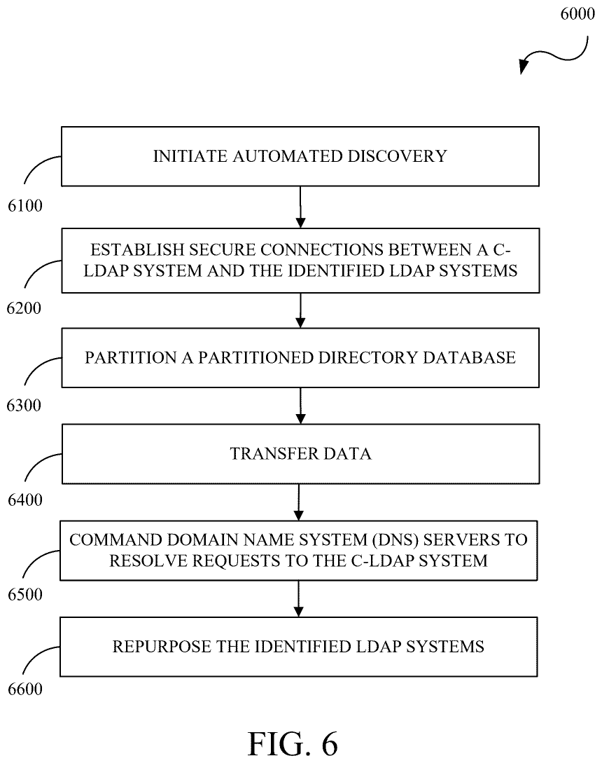

FIG. 6 is a flowchart of an example method 6000 for automated LDAP consolidation in accordance with the teachings described herein. The method 6000 includes: initiating 6100 automated discovery of LDAP systems deployed across an entity; establishing 6200 secure connections between a C-LDAP system and the identified LDAP systems; partitioning 6300 a partitioned directory database in response to data from the identified LDAP systems; transferring 6400 data from directory databases associated with the identified LDAP systems to the partitioned directory database; commanding 6500 domain name system (DNS) servers to resolve requests to the C-LDAP system; and repurposing 6600 one or more of the identified LDAP systems. The method 6000 can be implemented, for example, in or by components described with respect to FIGS. 3 and 8 and in conjunction with any of the flows described with respect to FIGS. 4-5, as appropriate and applicable.

The method 6000 includes initiating 6100 automated discovery of LDAP systems deployed across an entity. An orchestrating engine can trigger automated discovery or identification of LDAP systems that are present in the entity, which can be an enterprise, organization, and the like. The LDAP systems can be deployed on one or more networks used in the entity. In implementations, the one or more networks may not be or are not physically connected, logically connected, and/or combinations thereof. In implementations, the one or more networks are located in different locations. In implementations, the orchestrating engine can contact a central server at the entity to obtain the LDAP systems present at the entity.

The method 6000 includes establishing 6200 secure connections between a C-LDAP system and the identified LDAP systems. In implementations, a C-LDAP system can be provisioned onto and/or deployed in the entity. In implementations, one of the LDAP systems can be assigned as a C-LDAP system.

The method 6000 includes partitioning 6300 a partitioned directory database in response to data from identified LDAP systems. The orchestrating engine can partition a directory database based on the data about and from the LDAP systems. Identifiers can be added for each partition as related to the associated LDAP system and/or server.

The method 6000 includes transferring 6400 data from directory databases associated with the identified LDAP systems to the partitioned directory database. The orchestrating engine can send a message to request and/or command each of the local directory databases to transfer directory data to the partitioned directory database.

The method 6000 includes commanding 6500 domain name system (DNS) servers to resolve requests to the C-LDAP system. The DNS servers are instructed to resolve requests toward the C-LDAP as opposed to the local LDAP systems.

The method 6000 includes repurposing 6600 one or more of the identified LDAP systems. Identified LDAP systems are repurposed, taken offline, and/or combinations thereof. In implementations, repurposing can include, but is not limited to, acting as the C-LDAP system, acting as a load balancer LDAP system, acting as a security LDAP system, and/or combinations thereof.

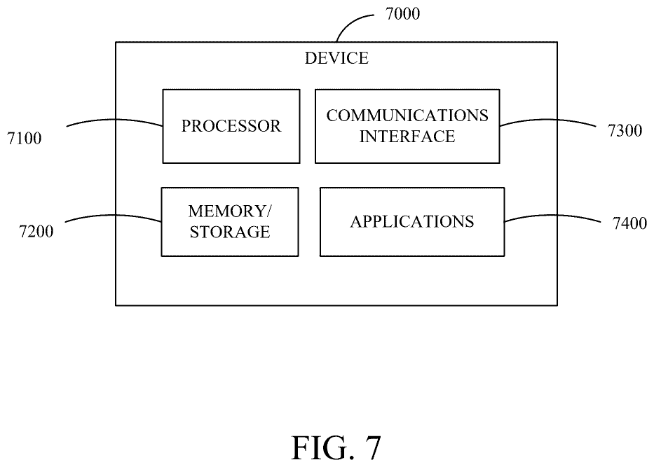

FIG. 7 is a block diagram of an example of a device 7000 in accordance with the teachings described herein. The device 7000 may include, but is not limited to, a processor 7100, a memory/storage 7200, a communication interface 7300, and applications 7400. The device 7000 may include or implement, for example, the systems and components described with respect to FIGS. 3-6 and the implement the methods of FIGS. 4-6. The applicable or appropriate flows, techniques, or methods described herein may be stored in the memory/storage 7200 and executed by the processor 7100 in cooperation with the memory/storage 7200, the communications interface 7300, and the applications 16400, as appropriate. The device 7000 may include other elements which may be desirable or necessary to implement the devices, systems, and methods described herein. However, because such elements and steps do not facilitate a better understanding of the disclosed embodiments, a discussion of such elements and steps may not be provided herein.

Disclosed is a method for automatically discovering and consolidating lightweight active directory protocol (LDAP) servers into a centralized-LDAP (C-LDAP). The method includes initiating, by an orchestration engine, automated discovery of LDAP systems deployed across an entity, establishing, by the orchestration engine, secure connections between a centralized LDAP (C-LDAP) system and identified LDAP systems, forming, by the orchestration engine, a partitioned directory database in response to data from the identified LDAP systems, requesting, by the orchestration engine, a directory database associated with an identified LDAP system to transfer directory data to the partitioned directory database, instructing, by the orchestration engine, one or more domain name system (DNS) servers to resolve requests directed to the identified LDAP systems to the C-LDAP system, and repurposing one or more of the identified LDAP systems.

In implementations, the identified LDAP systems are located across one or more networks deployed across the entity. In implementations, the method further includes provisioning the C-LDAP system on a network deployed in the entity. In implementations, one of the identified LDAP systems is repurposed as the C-LDAP system. In implementations, the method further includes removing certain of the identified LDAP systems from one or more networks deployed across the entity. In implementations, the repurposing further includes repurposing an identified LDAP system as a load balancer LDAP system. In implementations, the method further includes forwarding, by the C-LDAP system to the load balancer LDAP system, one or more requests received by the C-LDAP system when a number of requests exceeds or meets a defined threshold. In implementations, the repurposing further includes repurposing an identified LDAP system as a security LDAP system. In implementations, the method further includes forwarding, by the C-LDAP system to the security LDAP system, a request received by the C-LDAP system when the request requires an additional level of security.

Disclosed is a system for automatically discovering and consolidating lightweight active directory protocol (LDAP) servers into a centralized-LDAP (C-LDAP). The system includes a centralized lightweight active directory protocol (C-LDAP) system, a partitioned directory database connected to the C-LDAP, and a consolidation controller configured to identify lightweight active directory protocol (LDAP) systems deployed across multiple networks in an entity, establish secure connections between the C-LDAP system and identified LDAP systems, generate the partitioned directory database in response to data from the identified LDAP systems, instruct a directory database associated with an identified LDAP system to transfer directory data to the partitioned directory database, and request one or more domain name system (DNS) servers to resolve requests directed to the identified LDAP systems to the C-LDAP system, where some of identified LDAP systems are deactivated.

In implementations, one of the identified LDAP systems is repurposed as the C-LDAP system. In implementations, the system further includes a back-up C-LDAP system, wherein one of the identified LDAP systems is repurposed as the back-up C-LDAP system. In implementations, the system further includes a security LDAP system, where one of the identified LDAP systems is repurposed as the security LDAP system and the security LDAP system is configured to provide enhanced security to access certain services. In implementations, the system further includes a load balancer LDAP system, wherein one of the identified LDAP systems is repurposed as the load balancer LDAP system and the load balancer LDAP system is configured to provide additional resources when a number of requests meets or exceeds a defined threshold.

Disclosed is a method for automatically discovering and consolidating lightweight active directory protocol (LDAP) servers into a centralized-LDAP (C-LDAP). The method includes identifying, by an orchestration controller, lightweight active directory protocol (LDAP) systems deployed across multiple networks in an entity, establishing, by the orchestration controller, secure connections between a consolidated LDAP (C-LDAP) system and identified LDAP systems, generating, by the orchestration controller, a partitioned directory database in response to data from the identified LDAP systems, instructing, by the orchestration controller, each directory database associated with an identified LDAP system to transfer directory data to the partitioned directory database, requesting, by the orchestration controller, one or more domain name system (DNS) servers to resolve requests directed to the identified LDAP systems to the C-LDAP system, and removing some of the identified LDAP systems from the multiple networks.

In implementations, the method further includes provisioning the C-LDAP system on a network deployed in the entity. In implementations, one of the identified LDAP systems is repurposed as the C-LDAP system. In implementations, the method further includes repurposing an identified LDAP system as a load balancer LDAP system. In implementations, the method further includes forwarding, by the C-LDAP system to the load balancer LDAP system, one or more requests received by the C-LDAP system when a number of requests exceeds or meets a defined threshold. In implementations, the method further includes repurposing an identified LDAP system as a security LDAP system, and forwarding, by the C-LDAP system to the security LDAP system, a request received by the C-LDAP system when the request requires an additional level of security.

Although some teachings and/or embodiments herein refer to methods, it will be appreciated by one skilled in the art that they may also be embodied as a system or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “processor,” “device,” or “system.” Furthermore, aspects may take the form of a computer program product embodied in one or more the computer readable mediums having the computer readable program code embodied thereon. For example, the computer readable mediums can be non-transitory. Any combination of one or more computer readable mediums may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electromagnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to CDs, DVDs, wireless, wireline, optical fiber cable, RF, etc., or any suitable combination of the foregoing.

As used herein, the term “computer-readable medium” encompasses one or more computer-readable media. A computer-readable medium may include any storage unit (or multiple storage units) that store data or instructions that are readable by processing circuitry. A computer-readable medium may include, for example, at least one of a data repository, a data storage unit, a computer memory, a hard drive, a disk, or a random access memory. A computer-readable medium may include a single computer-readable medium or multiple computer-readable media. A computer-readable medium may be a transitory computer-readable medium or a non-transitory computer-readable medium.

Computer program code for carrying out operations for aspects may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects are described herein with reference to flowchart illustrations and/or block diagrams of methods, apparatus (systems) and computer program products according to teachings and/or embodiments. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowcharts and block diagrams in the figures illustrate the architecture, functionality, and operation of possible implementations of systems, methods, and computer program products according to various teachings and/or embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures.

While the disclosure has been described in connection with certain teachings and/or embodiments, it is to be understood that the disclosure is not to be limited to the disclosed teachings and/or embodiments but, on the contrary, is intended to cover various modifications, combinations, and equivalent arrangements included within the scope of the appended claims, which scope is to be accorded the broadest interpretation so as to encompass all such modifications and equivalent structures as is permitted under the law.

What is claimed is:

1. A method for automated lightweight active directory protocol (LDAP) systems consolidation, the method comprising:
initiating, by an orchestration engine, automated discovery of LDAP systems deployed across an entity;
establishing, by the orchestration engine, secure connections between a centralized LDAP (C-LDAP) system and identified LDAP systems;
forming, by the orchestration engine, a partitioned directory database in response to data from the identified LDAP systems;
requesting, by the orchestration engine, a directory database associated with an identified LDAP system to transfer directory data to the partitioned directory database;
instructing, by the orchestration engine, one or more domain name system (DNS) servers to resolve requests directed to the identified LDAP systems to the C-LDAP system; and
repurposing one or more of the identified LDAP systems.

2. The method of claim 1, wherein the identified LDAP systems are located across one or more networks deployed across the entity.

3. The method of claim 1, further comprising:
provisioning the C-LDAP system on a network deployed in the entity.

4. The method of claim 1, wherein one of the identified LDAP systems is repurposed as the C-LDAP system.

5. The method of claim 1, further comprising:
removing certain of the identified LDAP systems from one or more networks deployed across the entity.

6. The method of claim 1, wherein the repurposing further comprising:
repurposing an identified LDAP system as a load balancer LDAP system.

7. The method of claim 6, further comprising:
forwarding, by the C-LDAP system to the load balancer LDAP system, one or more requests received by the C-LDAP system when a number of requests exceeds or meets a defined threshold.

8. The method of claim 1, wherein the repurposing further comprising:
repurposing an identified LDAP system as a security LDAP system.

9. The method of claim 8, further comprising:
forwarding, by the C-LDAP system to the security LDAP system, a request received by the C-LDAP system when the request requires an additional level of security.

10. A system, comprising:
a centralized lightweight active directory protocol (C-LDAP) system;
a partitioned directory database connected to the C-LDAP system; and
a consolidation controller configured to:
identify lightweight active directory protocol (LDAP) systems deployed across multiple networks in an entity;
establish secure connections between the C-LDAP system and identified LDAP systems;
generate the partitioned directory database in response to data from the identified LDAP systems;
instruct a directory database associated with an identified LDAP system to transfer directory data to the partitioned directory database; and
request one or more domain name system (DNS) servers to resolve requests directed to the identified LDAP systems to the C-LDAP system, wherein some of identified LDAP systems are deactivated.

11. The system of claim 10, wherein one of the identified LDAP systems is repurposed as the C-LDAP system.

12. The system of claim 10, further comprising:
a back-up C-LDAP system, wherein one of the identified LDAP systems is repurposed as the back-up C-LDAP system.

13. The system of claim 10, further comprising:
a security LDAP system, wherein one of the identified LDAP systems is repurposed as the security LDAP system and the security LDAP system is configured to provide enhanced security to access certain services.

14. The system of claim 10, further comprising:
a load balancer LDAP system, wherein one of the identified LDAP systems is repurposed as the load balancer LDAP system and the load balancer LDAP system is configured to provide additional resources when a number of requests meets or exceeds a defined threshold.

15. A method for automatically consolidating lightweight active directory protocol (LDAP) systems, the method comprising:
identifying, by an orchestration controller, lightweight active directory protocol (LDAP) systems deployed across multiple networks in an entity;
establishing, by the orchestration controller, secure connections between a consolidated LDAP (C-LDAP) system and identified LDAP systems;
generating, by the orchestration controller, a partitioned directory database in response to data from the identified LDAP systems;
instructing, by the orchestration controller, each directory database associated with an identified LDAP system to transfer directory data to the partitioned directory database;
requesting, by the orchestration controller, one or more domain name system (DNS) servers to resolve requests directed to the identified LDAP systems to the C-LDAP system; and
removing some of the identified LDAP systems from the multiple networks.

16. The method of claim 15, further comprising:
provisioning the C-LDAP system on a network deployed in the entity.

17. The method of claim 15, wherein one of the identified LDAP systems is repurposed as the C-LDAP system.

18. The method of claim 15, wherein the method further comprising:
repurposing an identified LDAP system as a load balancer LDAP system.

19. The method of claim 18, further comprising:
forwarding, by the C-LDAP system to the load balancer LDAP system, one or more requests received by the C-LDAP system when a number of requests exceeds or meets a defined threshold.

20. The method of claim 15, wherein the method further comprising:
repurposing an identified LDAP system as a security LDAP system; and
forwarding, by the C-LDAP system to the security LDAP system, a request received by the C-LDAP system when the request requires an additional level of security.
